(19) United States
(12) Patent Application Publication
(10) Pub. No.: US 2013/0023220 A1
(43) Pub. Date: Jan. 24, 2013

(54) SIGNAL RECEIVING APPARATUS AND WIRELESS COMMUNICTION DEVICE

(71) Applicant: HAO CHEN, Shenzhen City (CN)

(72) Inventor: HAO CHEN, Shenzhen City (CN)

(73) Assignees: CHI MEI COMMUNICATION SYSTEMS, INC., Tu-Cheng (TW); SHENZHEN FUTAIHONG PRECISION INDUSTRY CO., LTD., ShenZhen City (CN)

(21) Appl. No.: 13/526,542

(22) Filed: Jun. 19, 2012

(30) Foreign Application Priority Data
Jul. 20, 2011 (CN) 201110203633.9

(51) Int. Cl. H04B 1/18; H04W 88/02

(52) U.S. Cl. 455/77; 455/193.1

(57) ABSTRACT

A signal receiving apparatus includes a first base member, a first coil, and a tuning circuit. The first coil is coiled around the first base member to from a first loop antenna having a plurality of parallel and spaced coil portions and two signal output terminals. The tuning circuit includes a first variable capacitor connected between the two signal output terminals.

### BACKGROUND

1. Technical Field

The disclosure generally relates to signal receiving apparatuses, and particularly to a signal receiving apparatus for a wireless communication device to receive amplitude modulation (AM) broadcasting signals of medium wave band.

2. Description of Related Art

Many wireless communication devices such as mobile phones or personal digital assistants (PDAs have functions, such as a global positioning system (GPS) function, a frequency modulation (FM) broadcasting receiving function, or a MP3 playing function. However, because of limitations of volume and cost of the wireless communication devices, the wireless communication devices having an amplitude modulation (AM) broadcasting receiving function often have a less than desired performance.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

FIG. 1 is a block diagram of a signal receiving apparatus for a wireless communication device, according to a first exemplary embodiment of the disclosure.

FIG. 2 is a schematic view of the signal receiving apparatus of FIG. 1.

FIG. 3 is a schematic view of a signal receiving apparatus, according to a second exemplary embodiment of the disclosure.

FIG. 4 is a schematic view of a signal receiving apparatus, according to a third exemplary embodiment of the disclosure.

### DETAILED DESCRIPTION

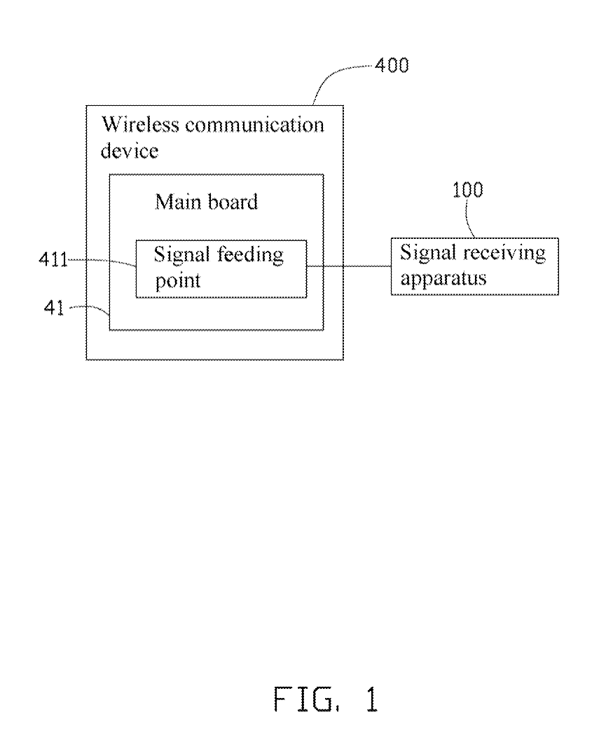

FIG. 1 is a schematic view of a signal receiving apparatus 100 for a wireless communication device 400, according to a first exemplary embodiment of the disclosure. The signal receiving apparatus 100 receives AM broadcasting signals of a medium wave band, according to a first exemplary embodiment of the disclosure. The wireless communication device 400 may be a mobile phone or a PDA and includes a main board 41 and a signal feeding point 411 positioned on the main board 41.

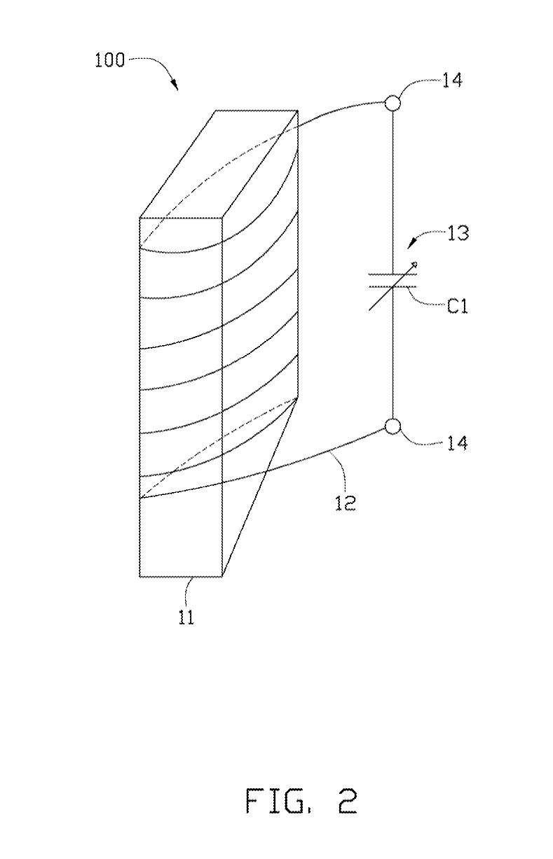

Referring to FIG. 2, the signal receiving apparatus 100 includes a first base member 11, a first coil 12, and a tuning circuit 13. In this embodiment, the first base member 11 is a rectangular hollow and insulating sleeve corresponding to the wireless communication device 400. The wireless communication device 400 is received in the first base member 11 and isolated from the first coil 12 by the first base member 11. The first coil 12 may be a radio frequency line, and coils around the first base member 11 forming a loop antenna having a plurality of parallel and spaced coil portions and two signal output terminals 14. The parallel and spaced coil portions are aligned on a surface of the first base member 11. The tuning circuit 13 includes a first variable capacitor C1 connected between the signal output terminals 14. A resonance frequency of the tuning circuit 13 can be adjusted by changing the first capacitor C1. When the resonance frequency of the first tuning circuit 13 is adjusted to be equal to a frequency of the desired channel, the desired channel can be selected.

In use, the wireless communication device 400 is received in the first base member 11. The signal feeding point 411 is electrically connected to the signal output terminals 14. The wireless communication device 400 can receive the AM broadcasting signals of medium wave band by adjusting capacitance of the first capacitor C1. Number of the coils and a size of a cross section of the first coil 12 can be changed to make sure the wireless communication device 400 can normally receive/transmit signals.

In other embodiments, the first base member 11 may be a battery or a battery cover of the wireless communication device 400, the first coil 12 coils around the battery or the battery cover.

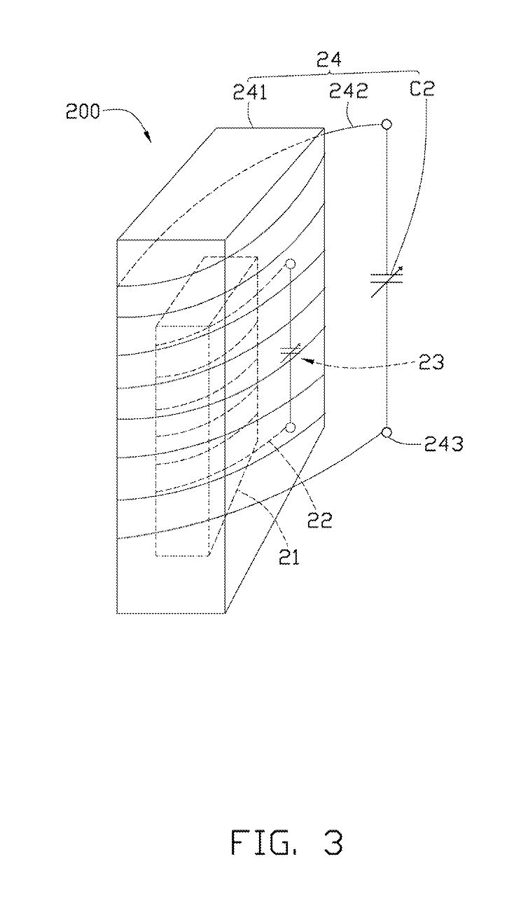

FIG. 3 is a signal receiving apparatus 200 according to a second exemplary embodiment of the disclosure. The signal receiving apparatus 200 is substantially similar to the signal receiving apparatus 100, and includes a first base member 21, a first coil 22, and a tuning circuit 23. The difference between the signal receiving apparatus 200 and the signal receiving apparatus 100 is that the signal receiving apparatus 200 further includes a resonating unit 24.

The resonating unit 24 includes a second base member 241, a second coil 242 and a second variable capacitor C2. In this embodiment, the second base member 241 is a rectangular hollow and insulating sleeve lager than the first base member 21. The first base member 21, the first coil 22, and the tuning circuit 23 are received in the second base member 241. The second coil 242 is coiled around the second base member 241 to form a second loop antenna having two connecting terminals 243. Two ends of the capacitor C2 are respectively connected to the connecting terminals 243.

In use, the wireless communication device 400 is received in the first base member 21. The first base member 21 together with the wireless communication device 400 is received in the second base member 241. The tuning circuit 23 resonates with the capacitor C2 and generates a resonate frequency for the wireless communication 400 to select a desired channel.

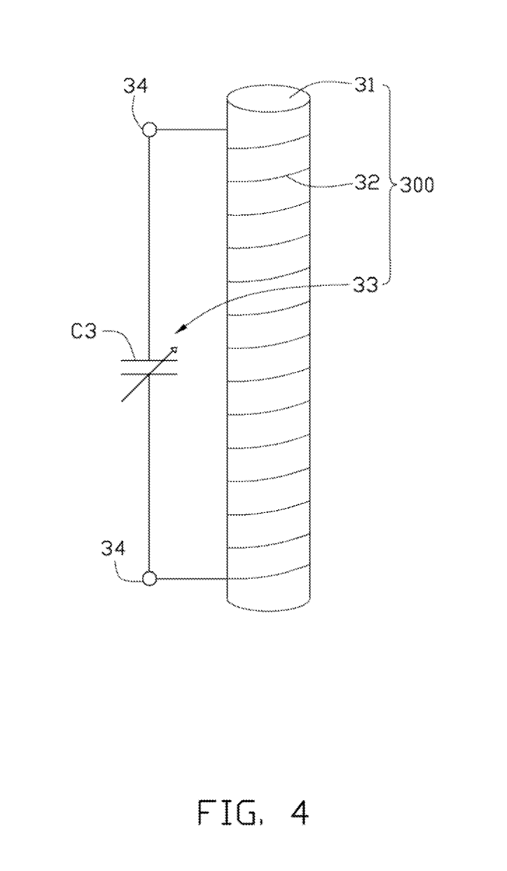

FIG. 4 is a signal receiving apparatus 300 according to a third exemplary embodiment of the disclosure. The signal receiving apparatus 300 is substantially similar to the signal receiving apparatus 100 and includes a first base member 31, a first coil 32, and a tuning circuit 22. The difference is that is the first base member 31 is a column magnetic core. The first coil 32 coils around the first base member 31 and forms a ferrite rod antenna having two signal output terminals 34. The tuning circuit 33 includes a first variable capacitor C3. The capacitor C3 is connected between the signal output terminals 34.

In use, the signal receiving apparatus 300 is assembled to the wireless communication device 400 by inserting the first base member 31 into one side of the wireless communication device 40. The signal output terminals 34 are electrically connected to the signal feeding point 411. In one embodiment, a dimension of the signal receiving apparatus 300 is about 30 mm*5 mm*3 mm.

In other embodiments, the tuning circuit 12, 23, 33 may be a conventional circuit or microchip having a tuning function. The circuit or microchip can be mounted on the main board 41 and electrically connected to the signal feeding point 411.

The signal receiving apparatus 100, 200, 300 realizes the AM broadcasting receiving function of the wireless communication device 400 without occupying volume of the wireless communication device 400 and enriches applications of the wireless communication device 400 with a low cost.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A signal receiving apparatus, comprising:
a first base member;
a first coil coiled around the first base member and forming a first loop antenna having a plurality of parallel and spaced coil portions and two signal output terminals; and
a tuning circuit comprising a first variable capacitor connected between the two signal output terminals.

2. The signal receiving apparatus of claim 1, wherein the first base member is a rectangular hollow and insulating sleeve.

3. The signal receiving apparatus of claim 1, wherein the first coil is a radio frequency line.

4. The signal receiving apparatus of claim 1, further comprising a resonating unit, wherein the first base member, the first coil, and the tuning circuit are received in the resonating unit, the resonating unit resonates with the tuning circuit.

5. The signal receiving apparatus of claim 4, wherein the resonating unit comprises a second base member, a second coil and a second variable capacitor, the second coil is coiled around the second base member to form a second loop antenna having two connecting terminals, the second capacitor is connected between the two connecting terminals.

6. The signal receiving apparatus of claim 5, wherein the second base member is a rectangular hollow and insulating sleeve, size of the second base member being larger than size of the first base member.

7. The signal receiving apparatus of claim 1, wherein the coils are aligned on a surface of the first base member.

8. The signal receiving apparatus of claim 1, wherein the first base member is a column magnetic core.

9. The signal receiving apparatus of claim 1, wherein the first base member is a battery or a battery cover of the wireless communication device.

10. A wireless communication device, comprising:
a main board comprising a signal feeding point, and
a signal receiving apparatus, the signal receiving apparatus comprising:
a first base member;
a first coil coiled around the first base member and forming a first loop antenna having a plurality of parallel and spaced coil portions and two signal output terminals, the two first signal output terminals connected to the signal feeding point; and
a tuning circuit comprising a first variable capacitor connected between the two signal output terminals.

11. The wireless communication device of claim 10, wherein the first base member is a rectangular hollow and insulating sleeve.

12. The wireless communication device of claim 10, wherein the first coil is a radio frequency line.

13. The wireless communication device of claim 10, further comprising a resonating unit, wherein the first base member, the first coil, and the tuning circuit are received in the resonating unit, the resonating unit resonates with the tuning circuit.

14. The wireless communication device of claim 13, wherein the resonating unit comprises a second base member, a second coil and a second variable capacitor, the second coil is coiled around the second base member to form a second loop antenna having two connecting terminals, the second capacitor is connected between the two connecting terminals.

15. The wireless communication device of claim 14, wherein the second base member is a rectangular hollow and insulating sleeve, size of the second base member being larger than the first base member.

16. The wireless communication device of claim 10, wherein the coils are aligned on a surface of the first base member.

17. The wireless communication device of claim 10, wherein the first base member is a column magnetic core.

18. The wireless communication device of claim 10, wherein the first base member is a battery or a battery cover of the wireless communication device.
